(19) United States
(12) Patent Application Publication
(10) Pub. No.: US 2021/0087335 A1
(43) Pub. Date: Mar. 25, 2021

(54) FLUORINATED POLY(ARYLENE ETHER) THERMOSET

(71) Applicant: SOLVAY SPECIALTY POLYMERS ITALY S.P.A., Bollate (IT)

(72) Inventors: Ritu AHUJA, Singapore (SG); Valeriy KAPELYUSHKO, Alessandria (IT); Ershad MISTRI, Mangalore, Karnataka (IN); Stefano MILLEFANTI, Tradate (IT); Mattia BASSI, Milano (IT)

(21) Appl. No.: 16/644,496

(22) PCT Filed: Aug. 31, 2018
(86) PCT No.: PCT/EP2018/073435

§ 371 Date: Mar. 4, 2020

(30) Foreign Application Priority Data
Sep. 4, 2017 (IN) 201721031305
Oct. 31, 2017 (EP) 17199300.9

(51) Int. Cl. C08G 65/40; C08G 65/48

(52) U.S. Cl. CPC C08G 65/4025; C08G 2150/00; C08G 2650/40; C08G 65/48

(57) ABSTRACT

The present invention relates to modified fluorinated poly(arylene ether ketone)s that can be crosslinked to produce high performance thermosets useful for semiconductor application with low dielectric constant. The present invention also relates to a method for manufacturing said modified fluorinated poly (arylene ether ketone)s prepared via polycondensation of a fluorinated poly (arylene ether ketone) with a fluorostyrene.

### CROSS-REFERENCE TO RELATED APPLICATIONS

This application claims priority to Indian provisional patent application No. 201721031305 filed on 4 Sep. 2017 and to European application No. 17199300.9 filed on 31 Oct. 2017, the whole content of those applications being incorporated herein by reference for all purposes.

### TECHNICAL FIELD

The present invention relates to modified fluorinated poly(arylene ether ketone)s that can be crosslinked to produce high performance thermosets useful for semiconductor application with low dielectric constant.

The present invention also relates to a method for manufacturing said modified fluorinated poly(arylene ether ketone)s prepared via polycondensation of a fluorinated poly(arylene ether ketone) with a fluorostyrene.

### BACKGROUND ART

The electronic industry has recently sought materials with low dielectric constant and dielectric loss, for use as in electronic devices.

Considerable research has been devoted to polymeric dielectric materials due to their ease of manufacturing, high breakdown strength, low loss and self-clearing capabilities.

Several approaches can be found in the literature to reduce the dielectric constant of polymeric materials. Among those, introducing fluorine and free volumes in the material are methods known in the art to enhance electronic properties. In particular, fluorine is widely utilized for reducing dielectric constant of materials because it can reduce the strength of dipoles. On the other side, crosslinking is known to offer free volumes in the system and increasing free volumes in the system means decreasing number of dipoles to minimize dielectric constant.

US2004/0127632 (ZEN PHOTONICS CO. LTD.) Jan. 7, 2004, discloses fluorinated polymer compounds having pentafluorostyrene introduced at the terminal thereof for use in the fabrication of thin films that can be UV or thermally cured to obtain optical waveguide devices. With the aim of achieving the desired curing density it is suggested to use said fluorinated compounds in admixture with photoinitiators and acrylate compounds.

Fluorinated poly(arylene ether)s (fluorinated PAEKs) are the dielectric material of choice for many applications in the electronic industry because of their low dielectric constant, a low electrical current loss factor at high frequencies, low moisture absorption, low cure temperature, good thermal stability, excellent chemical resistance and good compatibility with various metallization systems. They are largely used in electronic packaging for electronic devices. They also find applications as insulating materials in microelectronics.

Most of these polymers have been synthesized by solution polycondensation of the corresponding fluorine-substituted monomer, which are quite expensive monomers to be used.

Patent document US2004198906 (NATIONAL RESEARCH COUNCIL OF CANADA) Apr. 12, 2003, discloses crosslinkable highly fluorinated poly(arylene ether)s comprising fluorostyrene residues as end-caps or as pendant groups, said fluorinated poly(arylene ether)s being prepared by reacting a bis(pentafluorophenyl) compound with a bisphenol or a hydroquinone. Said compounds are described to be useful as passive optic polymer waveguide materials for telecommunication applications. The presence of fluorine atoms in the polymer backbone structure is disclosed as providing improved optical properties.

A drawback of the fluorinated PAEK known in the art is the low entanglement molecular weight that can pose problems in casting thin films.

It would be advantageous to have poly(arylene ether) polymers having improved melt viscosity, improved thermal and mechanical properties and low dielectric constant that can be prepared by a simple process.

### SUMMARY OF INVENTION

The Applicant has now surprisingly found that certain fluorinated poly(arylene ether ketone) polymers bearing fluorostyrene end groups can be crosslinked to produce cured films that are particularly suitable for use in many applications in dielectric utilities because offer low dielectric constant and are easy to prepare.

The present invention hence is directed, in a first aspect, to a fluorinated poly(arylene ether ketone) bearing fluorostyrene groups of formula (I) [F-PAEK-PFS]:

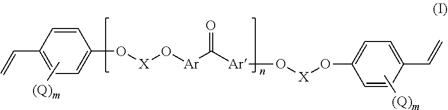

wherein n is an integer of from 1 to 200;
Ar and Ar′, equal to or different from each other, are aromatic groups selected from phenylene or naphtylene groups;
each Q is a fluorine atom or a —CF₃ group and each m is an integer from 1 to 4;
with X being a bisphenol moiety of formula:

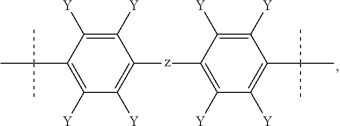

wherein Y is hydrogen or fluorine and Z is an alkylic or aromatic fluorinated moiety.

The invention further pertains to a method for manufacturing the F-PAEK-PFS of formula (I) as above detailed, said method comprising:
(i) providing a fluorinated poly(arylene ether ketone) of formula (II) [F-PAEK]

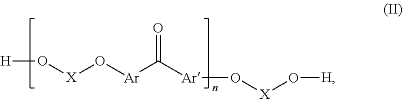

wherein n, Ar, Ar′ and X are as above defined; and
(ii) reacting the F-PAEK obtained in step (i) with a fluorostyrene of formula:

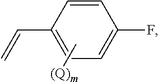

wherein Q is a fluorine atom or a —CF₃ group and m is an integer from 1 to 4.

The Applicant found that, advantageously, the F-PAEK-PFS can be UV or thermally cured to get thermoset materials having improved thermal, mechanical and chemical stability as well as low dielectric constant.

In a further aspect, thus, the present invention relates to a thermoset material obtainable by crosslinking the F-PAEK-PFS [thermoset (T)] and to articles comprising said thermoset (T).

### DESCRIPTION OF EMBODIMENTS

In the context of the present invention, the use of parentheses “( . . . )” before and after symbols or numbers identifying formulae or parts of formulae has the mere purpose of better distinguishing that symbol or number with respect to the rest of the text; thus, said parentheses could also be omitted.

### F-PAEK

For the purpose of the invention, the term “fluorinated poly(arylene ether ketone) [F-PAEK]” is intended to denote any polymer comprising recurring units (R_{F-PAEK}) of formula:

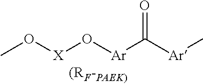

wherein Ar and Ar′, equal to or different from each other, are aromatic groups selected from phenylene or naphtylene groups; and
X is a bisphenol moiety of formula:

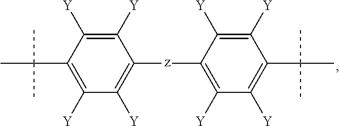

wherein Y is hydrogen or fluorine and Z is an alkylic or aromatic fluorinated moiety.

The term “alkylic fluorinated radical” is intended to refer to linear, branched or cyclic hydrocarbon chain in which some or all of the hydrogen atoms are replaced with fluorine atoms, wherein said chain may be optionally unsaturated and wherein one or more carbon atoms may be replaced by heteroatom(s) such as 0 or S, preferably 0.

The alkylic fluorinated radical is preferably selected from the group consisting of:

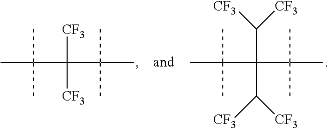

The term “aromatic fluorinated radical” refers to a radical derived from an aromatic system having 6 to 18 carbon atoms including, but not limited to, phenyl, biphenyl, naphthyl, anthracenyl and the like, in which some or all of the hydrogen atoms are replaced with one or more of a fluorine atom and a —CF₃ group.

The aromatic fluorinated radical is preferably selected from the group consisting of:

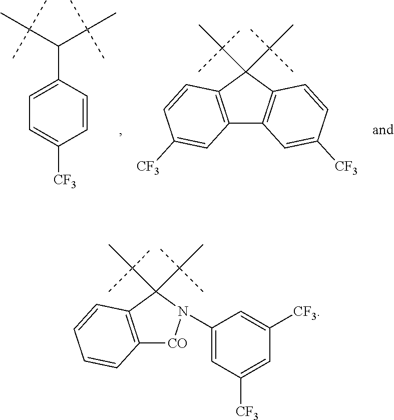

Ar and Ar′, equal to or different from each other, are aromatic groups selected from phenylene or naphtylene groups which may optionally be substituted with at least one substituent selected from the group consisting of alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; the at least one substituent may optionally contain one or more fluorine atoms.

F-PAEK polymers suitable for use in the present invention can be homopolymers, thus comprising essentially a single repeating unit (R_{F-PAEK}), or copolymers such as random, alternate or block copolymer.

When the F-PAEK polymer is a copolymer, it may notably contain at least two different recurring units (R_{F-PAEK}) including X moieties having different meanings among those above defined.

Preferably, F-PAEK polymer is a homopolymer.

The F-PAEK can be prepared by polycondensation of a bisphenol of formula (A):

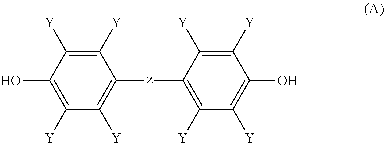

wherein Y is hydrogen or fluorine and Z is an alkylic or aromatic fluorinated moiety,
with a compound of formula F—Ar—C(O)—Ar′—F, wherein Ar and Ar′ are as above defined.

In a preferred embodiment, the F-PAEK used in the present invention has a number average molecular weight (Mn) comprised between 1000 and 30000, preferably between 1500 and 10000 more preferably 8000.

The F-PAEK used in the present invention generally has a polydispersity index (PDI) of less than 5, preferably of less than 4, more preferably of less than 3.5.

This relatively narrow molecular weight distribution is representative of an ensemble of molecular chains with similar molecular weights.

In a preferred embodiment, the F-PAEK is the compound of formula:

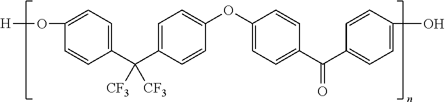

wherein n is an integer of from 1 to 200.

### Fluorinated Poly(Arylene Ether Ketone) Bearing Fluorostyrene Groups [F-PAEK-PFS]

For the purpose of the invention, the term “fluorinated poly(arylene ether ketone) bearing fluorostyrene groups [F-PAEK-PFS]” is intended to denote any polymer of formula (I):

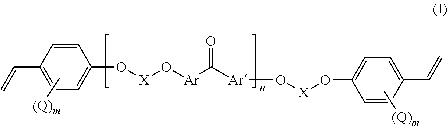

wherein n, X, Ar, Ar′, Q and m are as above defined.

In a preferred embodiment, each m is the integer 4, and each Q is a fluorine atom.

F-PAEK-PFS of the present invention advantageously possess a number average molecular weight (Mn) comprised between 1000 and 30000.

F-PAEK-PFS of the present invention generally have a glass transition temperature of at least 100° C., preferably at least 140° C., more preferably at least 150° C.

Glass transition temperature (Tg) is generally determined as the midpoint temperature measured by DSC, according to ASTM D3418.

In a preferred embodiment, F-PAEK-PFS of the present invention is the compound of formula:

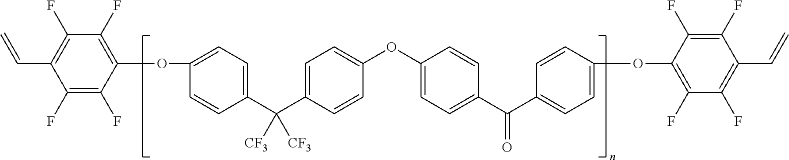

Additives can be used to enhance or impart particular target properties to F-PAEK-PFS, as it is conventionally known in the polymer art, including stabilizers, flame retardants, pigments, plasticizers, surfactants and the like.

The invention further pertains to a method for manufacturing the F-PAEK-PFS as above detailed.

The reaction with a fluorostyrene in step (ii) provides modified F-PAEK wherein fluorostyrene moieties are introduced at chain ends, thus introducing end-capping crosslinking functionalities.

Preferably, the fluorostyrene used in step (ii) is pentafluorostyrene (PFS), and the reaction with F-PAEK provides modified F-PAEK wherein tetrafluorostyrene moieties are introduced at chain ends.

Reaction step (ii) can be carried out according to procedures known in the art.

Reaction temperature in step (ii) is usually comprised between 20 and 150° C., preferably between 50 and 100° C.

The duration of step (ii) is usually comprised between 2 and 25 hours, preferably from 10 to 20 hours.

The extent of the reaction of the F-PAEK with PFS may be followed by titration methods, by monitoring the amount of —OH groups, which decreases with time indicating the conversion of hydroxy groups of F-PAEK to fluorostyrene end groups.

The formation of F-PAEK-PFS may be confirmed by nuclear magnetic resonance, ¹H-NMR and ¹⁹F-NMR, after dissolution of the samples in chloroform.

The process for the preparation of crosslinkable F-PAEK-PFS offers many advantages over existing processes. This includes mild reaction condition, low processing temperature, no side reaction, high degree of reproducibility, and easy control.

The F-PAEK-PFS obtained by the method according to the present invention is preferably in the form of powder.

Though, flexible and transparent films of the F-PAEK-PFS of the present invention can be readily prepared by solution techniques such as spraying, spin coating, bar coating or casting, with bar coating being preferred.

Sai techniques are advantageously performed by dissolving the F-PAEK-PFS in at least one solvent. Preferred solvents for F-PAEK-PFS include chloroform, dichloromethane, tetrahydrofuran, cyclopentanone and cyclohexanone, dimethylacetamide.

Thus, another object of the present invention is a film of F-PAEK-PFS.

Typically, the thickness of films of F-PAEK-PFS of the present invention is comprised between 1 and 50 micron.

Films of F-PAEK-PFS can be used to coat on substrate or can form a free standing film after heating or UV-irradiation on it for a certain time, which cure compound F-PAEK-PFS.

The Applicant found that, advantageously, the F-PAEK-PFS, either in the form of powder or in the form of film, can be directly crosslinked to get a thermoset material through reaction of the fluorostyrene end groups.

In a further object, thus, the present invention provides a method to obtain a thermoset material [Thermoset (T)] by crosslinking a F-PAEK-PFS of the present invention.

Crosslinking of F-PAEK-PFS may be achieved by thermal heating (thermal crosslinking) or UV radiation (photo crosslinking).

Thermal crosslinking can be carried out on F-PAEK-PFS in the form of powder or in the form of film, preferably on films, by heating the F-PAEK-PFS at a temperature that may vary from about 150° C. to about 400° C., preferably at a temperature of about 300°, more preferably 200° C.

Photo crosslinking may be carried out on F-PAEK-PFS in the form of powder or in the form of film, preferably on films, by exposing a composition comprising F-PAEK-PFS and at least one photoinitiator to UV light in the range of 190-400 nm.

Any suitable photoinitiator may be used which is capable of initiating crosslinking of the reactive fluorostyrene upon exposure to UV light.

Non-limiting examples of useful photoinitiators include a benzoine alkyl ether derivative, a benzophenone derivative, an α-aminoalkylphenone type, an oxime ester derivative, a thioxanthone derivative, an anthraquinone derivative, an acylphosphineoxide derivative, a glyoxyester derivative, an organic peroxide type, a trihalomethyltriazine derivative or a titanocene derivative. Specifically, IRGACURE® 651, IRGACURE® 184, DAROCUR® 1173, IRGACURE® 500, IRGACURE® 2959, IRGACURE® 754, IRGACURE® 907, IRGACURE® 369, IRGACURE® 1300, IRGACURE® 819, IRGACURE® 819DW, IRGACURE® 1880, IRGACURE® 1870, DAROCUR® TPO, DAROCUR® 4265, IRGACURE® 784, IRGACURE® OXE01, IRGACURE® OXE02 or IRGACURE® 250 (manufactured by Ciba Specialty Chemicals K.K.), KAYACURE DETX-S, KAYACURE CTX, KAYACURE BMS or KAYACURE 2-EAQ (manufactured by Nippon Kayaku Co., Ltd.), TAZ-101, TAZ-102, TAZ-103, TAZ-104, TAZ-106, TAZ-107, TAZ-108, TAZ-110, TAZ-113, TAZ-114, TAZ-118, TAZ-122, TAZ-123, TAZ-140 or TAZ-204 (manufactured by Midori Kagaku Co., Ltd.) may, for example, be mentioned.

The crosslinking can be verified by determining the glass transition temperature (Tg) of the crosslinked F-PAEK-PFS, which markedly increases after the crosslinking reaction.

Glass transition temperature (Tg) of F-PAEK-PFS-thermoset is generally determined as the midpoint temperature measured by DSC, according to ASTM D3418.

The crosslinking can also be verified by solubility tests on films of the F-PAEK-PFS-thermoset at the end of the curing. Solubility of films of F-PAEK-PFS-thermoset films can be studied in different types of solvent: the absence of solubilization in said solvents is the confirmation of crosslinking.

The thermosets (T) of the present invention advantageously show improved thermal and mechanical properties, low dielectric constant, low dielectric loss, low moisture absorption and flame retardancy, and have the additional advantage of being prepared by a simple process.

The obtained crosslinked films of thermoset (T) are transparent, which is favorable for optoelectronics applications.

In a further aspect, thus, the present invention relates to articles comprising a thermoset (T).

The thermoset (T) of the present invention can be used as in the chemical, electronic and semiconductor industries, and is suitable for fabricating O-rings, V-rings, gaskets and diaphragms.

It can also be cast onto a reinforcement to prepare a laminate for use as a substrate for electronic circuit devices.

Should the disclosure of any patents, patent applications, and publications which are incorporated herein by reference conflict with the description of the present application to the extent that it may render a term unclear, the present description shall take precedence.

The invention will be now described in more details with reference to the following examples whose purpose is merely illustrative and not limitative of the scope of the invention.

### Raw Materials:

All starting materials received from commercial source and used as such without any further purification.

### Thermal Analyses

DSC measurements were performed on a Q2000—TA instruments in N₂ atmosphere.

### Mechanical Property Measurements

Mechanical properties were measured on a ZWICK Z030 with 30 kN load cell using ASTM D638 Type V specimen.

### UV Curing

UV curing was carried out on casted polymer films using Helios Quartz UV curing test apparatus under constant flow of N₂ at RT for 10 min with 1 min intervals

### Example 1

### Synthesis of F-PAEK:

40 g of 4,4′-difluorobenzophenone (DFBP hereinafter, 0.183 mol) was reacted with 64.72 g of 4,4′-hexafluoroisopropylidenediphenol (BPA-F hereinafter, 0.192 mol) and N-methyl-2-pyrrolidone (NMP, 400 mL) were charged into to a three-neck flask equipped with a N₂ inlet, mechanical stirrer, and Dean-Stark trap. 100 mL of toluene and 39.9 g of K2003 (0.289 mol) were added to the flask and the Dean-Stark trap was filled with toluene. The mixture was heated to 80° C. with continuous stirring under N₂ flow until DFBP, BPA-F and K₂CO₃ were completely dissolved. Then the temperature was increased to 150° C. to begin azeotropic removal of water. After 2-3 h toluene and water were removed from the Dean-Stark trap. Thereafter, the temperature was maintained at 150° C. for 12 h. Progress of the reaction was monitored by online GPC. After reaching the desired molecular weight the polymer solution was precipitated into deionized water. It was washed thoroughly with deionized water followed by 5% HCl solution. Next it was washed with hot water till the solution became neutral.

The polymer so obtained was further dissolved in dichloromethane and then re-precipitated in methanol. Finally, the white polymer powder was filtered and dried at 80° C. under vacuum.

Yield=80%. Mn=7200, PDI=3.9

### Example 2

### Synthesis of F-PAEK-PFS

In a 3-neck round bottomed flask equipped with a magnetic stirrer and N₂ inlet, 20 g (25.35 mmol) of F-PAEK obtained as in example 1 were dissolved in 180 mL of NMP. 1.29 g of K2003 (1.3 eqv. with respect to the total amount of —OH end groups of F-PAEK) were added and stirred to dissolve at 60° C. for 2-3 h. Next, 3.344 g of pentafluorostyrene (PFS) (1.2 eqv. with respect to the total amount of —OH end group of F-PAEK) were added to the reaction mixture and the temperature was increased to 90° C. Reaction was continued for 18 h at this temperature. After completion of the reaction the amount of —OH end groups was reduced to 0, from the beginning value of 684 μeq/g. The reaction mass was precipitated in water. It was washed thoroughly with water followed by methanol. Dry polymer obtained after drying under vacuum oven at 70° C. for 6 h. Yield=83%. Mn=7600, PDI=3.2

### Example 3

F-PAEK-PFS was also prepared in a single step without the isolation of F-PAEK. In this procedure Example 1 was followed but before isolation of the product, stoichiometric amount of PFS (with respect to the —OH end group) was added in the same pot instead of following example 2 wherein PFS was added to the product of example 1. Mn=8800, PDI=3.4. Yield=75%. >99% end-capped product obtained as monitored by the reduction of —OH value. The formation of the end-capped product was confirmed by ¹H-NMR and ¹⁹F-NMR. The spectral signals were well assigned to the magnetically different protons of the polymer repeating unit structure. In ¹⁹F-NMR, two new signals arose at −144 and −156 ppm from the tetrafluorostyrene linked to the F-PAEK, instead of three signals for free PFS. This confirmed the successful end-capping reaction of PFS to the F-PAEK.

### Example 4

### UV Photo Curing of F-PAEK-PFS Film

The photo-crosslinking was done by exposing a film of F-PAEK-PFS to UV light with several minutes irradiation time.

Firstly, the F-PAEK-PFS obtained in example 2 was mixed with a photoinitiator (Irgacure® 651, 2 wt % with respect to the F-PAEK-PFS) and dissolved in cyclopentanone (10% w/v). After complete dissolution, the solution was filtered through a Teflon® membrane filter to remove fine particles having a size of 0.2 μm. Thereafter, the filtered solution was poured in a petri dish and dried under vacuum oven at 50° C. overnight. Thereafter, the film was exposed to UV light for 10 minutes under nitrogen atmosphere. Then, the film was post baked in oven at 100° C., 120° C. and 140° C. each for 2 h. To remove the residual solvent, the films were further dried at 150° C. under vacuum oven for overnight. A transparent and flexible crosslinked film was obtained.

The crosslinked film showed the following mechanical and thermal properties:

Tensile strength (MPa): 57±10.7

### Modulus (GPa): 2.75±0.2

Elongation at break (%): 2.7±0.3

### Tg (° C.): 153.

1. A fluorinated poly(arylene ether ketone) bearing fluorostyrene groups of formula (I) [F-PAEK-PFS] 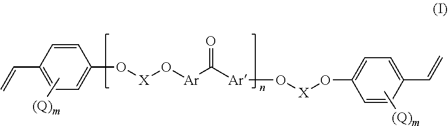
wherein n is an integer of from 1 to 200;
Ar and Ar′, equal to or different from each other, are aromatic groups selected from phenylene or naphtylene groups;
each Q is a fluorine atom or a —CF₃ group and each m is an integer from 1 to 4;
with X being a bisphenol moiety of formula: 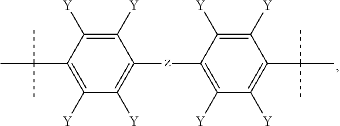
wherein Y is hydrogen or fluorine and Z is an alkylic or aromatic fluorinated moiety.

2. The F-PAEK-PFS according to claim 1 wherein Z is an alkylic fluorinated moiety selected from the group consisting of:

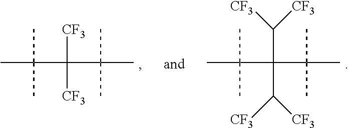

3. The F-PAEK-PFS according to claim 1 wherein Z is an aromatic fluorinated moiety selected from the group consisting of:

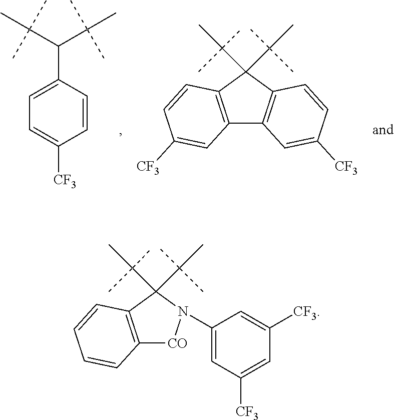

4. The F-PAEK-PFS according to claim 1 having a number average molecular weight comprised between 1000 and 30000, and a glass transition temperature of at least 100° C. wherein the number average molecular weight is determined by GPC and the glass transition temperature is determined as the midpoint temperature measured by DSC, according to ASTM D3418.

5. The F-PAEK-PFS according to claim 1 which is in the form of a film.

6. The F-PAEK-PFS according to claim 1 which is the compound of formula: 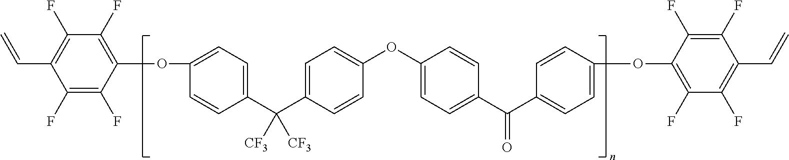
wherein n is an integer of from 1 to 200.

7. A method for manufacturing the F-PAEK-PFS according to claim 1, said method comprising:
reacting a fluorinated poly(arylene ether ketone) of formula (II) [F-PAEK] 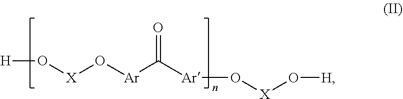
with a fluorostyrene of formula: 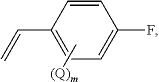
wherein:
n is an integer of from 1 to 200;
Ar and Ar′, equal to or different from each other, are aromatic groups selected from phenylene or naphtylene groups;
with X being a bisphenol moiety of formula: 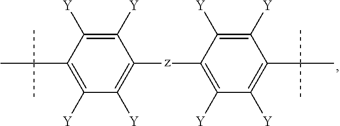
wherein Y is hydrogen or fluorine and Z is an alkylic or aromatic fluorinated moiety;
Q is a fluorine atom or a —CF₃ group; and
m is an integer from 1 to 4.

8. The method according to claim 7 wherein the F-PAEK has a number average molecular weight comprised between 1000 and 20000 and a polydispersity index of less than 2.5, wherein the number average molecular weight and the polydispersity index are determined by GPC.

9. The method according to claim 7 wherein the F-PAEK is the compound of formula: 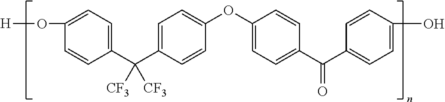
wherein n is an integer of from 1 to 200.

10. A method to prepare a thermoset material [thermoset (T)], said method comprising crosslinking a F-PAEK-PFS of claim 1.

11. The method according to claim 10 wherein the crosslinking is thermal or photo crosslinking.

12. The method according to claim 11 wherein the photo crosslinking is carried out by exposing a composition comprising F-PAEK-PFS and at least one photoinitiator to UV light in the range of 190-400 nm.

13. A thermoset material [thermoset (T)] comprising at least one crosslinked F-PAEK-PFS of claim 1.

14. An article comprising the thermoset (T) according to claim 13.

15. The F-PAEK-PFS according to claim 4 having a glass transition temperature of at least 140° C., wherein the glass transition temperature is determined as the midpoint temperature measured by DSC, according to ASTM D3418.

16. The F-PAEK-PFS according to claim 6 which is in the form of a film.

17. The method according to claim 8 wherein the F-PAEK has a number average molecular weight comprised between 1500 and 10000 and a polydispersity index of less than 2.2, wherein the number average molecular weight and the polydispersity index are determined by GPC.
